(19) United States
(12) Patent Application Publication
(10) Pub. No.: US 2013/0080830 A1
(43) Pub. Date: Mar. 28, 2013

(54) SETTING DATA STORAGE FOR SEMICONDUCTOR DEVICES INCLUDING MEMORY DEVICES AND SYSTEMS

(71) Applicant: Sam-Kyu WON, Icheon-si (KR)

(72) Inventor: Sam-Kyu WON, Icheon-si (KR)

(73) Assignee: SK HYNIX INC., Icheon-si (KR)

(21) Appl. No.: 13/549,978

(22) Filed: Jul. 16, 2012

(30) Foreign Application Priority Data
Sep. 22, 2011 (KR) 10-2011-0095763

(51) Int. Cl. G06F 11/14

(52) U.S. Cl. 714/15; 714/E11.117

(57) ABSTRACT

A setting data storage circuit includes a setting data storage block configured to store setting data; an access unit configured to access the setting data of the setting data storage block; an error detection unit configured to detect an error in the setting data; and an error recovery unit configured to recover an error in the setting data storage block when the error detection unit detects an error.

### CROSS-REFERENCE TO RELATED APPLICATIONS

The present application claims priority of Korean Patent Application No. 10-2011-0095763, filed on Sep. 22, 2011, which is incorporated herein by reference in its entirety.

### BACKGROUND

1. Field

Exemplary embodiments of the present invention relate to memory system setting information storage, and more particularly to a setting data storage circuit for storing setting information utilized for operations of various devices such as a nonvolatile memory device.

2. Description of the Related Art

High performance mobile products such as camcorders, digital cameras, portable phones, MP3 (MPEG-1 Layer3) players, etc. are in demand.

Most, if not all, of these mobile products require memory devices as subcomponent parts. The internal options or the settings of the memory devices, typically of a non-volatile type, that are to be applied in the mobile products are determined in conformity with the operational characteristics of the mobile products so as to allow the memory devices to operate in harmony with the application programs running in the mobile products. As more and more applications run in the mobile products with advancement of the mobile technologies, the traditional way of using fuses to set the internal options or the settings of a nonvolatile memory device for use in the mobile products has many limitations. Conventionally, fuses in a nonvolatile memory are used to store the setting information; however, in the highly integrated, high performance mobile integrated circuits, the circuit area occupied by the fuses would likely become substantially large. To circumvent this problem, the content addressable memory (CAM) cells are often used instead of the fuses to store the setting information.

Typically, read operations are only allowed to access the information stored in the CAM cells. Once the CAM cells are written with information by a manufacturer prior to putting the device on the market, the CAM cells are not allowed to be re-written by a user or a controller. In a nonvolatile NAND flash memory, for example, the setting information is stored in a certain block of the memory. To ensure the CAM cell reliability, the same data are written several times in one page. When performing a CAM cell read operation, the data written in the page over several times are read, and the read data are compared. The same data that have been consistently read over a majority of times are then recognized as the true or correct data. However, when data in a nonvolatile memory are read over a so many number of times, the nonvolatile memory due to its inherent read disturbance characteristics could eventually lose the ability to retain the stored data. Thus, it is possible that the CAM cell data could be lost in the nonvolatile memory when the CAM cell data were to be subjected to the repeated reading operations for so many number of times as a part of procedure to ensure the integrity of the data read.

### SUMMARY

The reliability of a setting information storage circuit is improved according to an embodiment of the present invention.

In accordance with an embodiment of the present invention, a setting data storage circuit may include: a setting data storage block configured to store setting data; an access unit configured to access the setting data of the setting data storage block; an error detection unit configured to detect an error in the setting data; and an error recovery unit configured to recover an error in the setting data storage block when the error detection unit detects an error.

The setting data may be stored the same in at least two regions (such as pages) in the setting data storage block. The error detection unit may detect an error by comparing the setting data which are stored in different regions in the setting data storage block. The error recovery unit may change a region used for reading of the setting data in the setting data storage block when the error detection unit detects an error, or may control the access unit such that the setting data are rewritten in the setting data storage block when the error detection unit detects an error.

Further, according to an embodiment of the present invention, a setting data storage circuit may include: a setting data storage block configured to store setting data; an access unit configured to access the setting data of the setting data storage block; a counter configured to count the number of times by which the access unit accesses the setting data; and an error recovery unit configured to recover the setting data storage block when the number of access times counted by the counter is identical to or greater than a predetermined number of times.

The counter may be initialized when the error recovery unit performs a recovery operation. The counter may count the number of access times by counting the number of power-up times of a system including the setting data storage circuit.

Yet further according to an embodiment of the present invention, a nonvolatile memory device may include: a plurality of normal data storage blocks configured to store normal data; a setting data storage block configured to store setting data; a page buffer array configured to access the data of the plurality of normal data storage blocks and the setting data storage block; an error detection unit configured to detect an error in the setting data; and an error recovery unit configured to recover an error in the setting data storage block when the error detection unit detects an error.

Still further according to an embodiment of the present invention, a nonvolatile memory device may include: a plurality of normal data storage blocks configured to store normal data; a setting data storage block configured to store setting data; a page buffer array configured to access the data of the plurality of normal data storage blocks and the setting data storage block; a counter configured to count the number of power-up times; and an error recovery unit configured to recover the setting data storage block when the number of power-up times is identical to or greater than a predetermined number of times.

According to an embodiment of the present invention, a memory system may include a nonvolatile memory device and a controller for controlling the nonvolatile memory device, the nonvolatile memory device including: a plurality of normal data storage blocks configured to store normal data; a setting data storage block configured to store setting data; a page buffer array configured to access the plurality of normal data storage blocks and the setting data storage block; and an error recovery unit configured to recover the setting data storage block in response to an error recovery command, wherein the controller counts the number of power-up times of the nonvolatile memory device and applies the error recovery command to the nonvolatile memory device when the number of power-up times is identical to or greater than a predetermined number of times.

Yet further according to an embodiment of the present invention, a memory system may include a nonvolatile memory device and a controller for controlling the nonvolatile memory device, the nonvolatile memory device including: a plurality of normal data storage blocks configured to store normal data; a setting data storage block configured to store setting data; a page buffer array configured to access the plurality of normal data storage blocks and the setting data storage block; an error detection unit configured to detect an error in the setting data and notify occurrence of an error to the controller when an error is detected; and an error recovery unit configured to recover an error in the setting data storage block, wherein, when occurrence of an error is notified from the nonvolatile memory device, the controller controls the error recovery unit of the nonvolatile memory device to recover an error in the setting data storage block.

### BRIEF DESCRIPTION OF THE DRAWINGS

FIG. 1 is a configuration diagram of a memory device including a nonvolatile memory in accordance with an embodiment of the present invention.

FIG. 2 is a flow chart showing a scheme in which the error detection unit shown in FIG. 1 detects an error.

FIG. 3 is a flow chart showing a first recovery scheme in which the error recovery unit shown in FIG. 1 recovers an error by changing a region (such as a page) for reading of setting data in a setting data storage block.

FIG. 4 is a flow chart showing a second recovery scheme in which the error recovery unit shown in FIG. 1 recovers an error by rewriting the setting data of the setting data storage block.

FIG. 5 is a configuration diagram of a memory device including a nonvolatile memory in accordance with an embodiment of the present invention.

FIG. 6 is a configuration diagram of a memory system in accordance with an embodiment of the present invention.

FIG. 7 is a configuration diagram of a memory system in accordance with an embodiment of the present invention.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

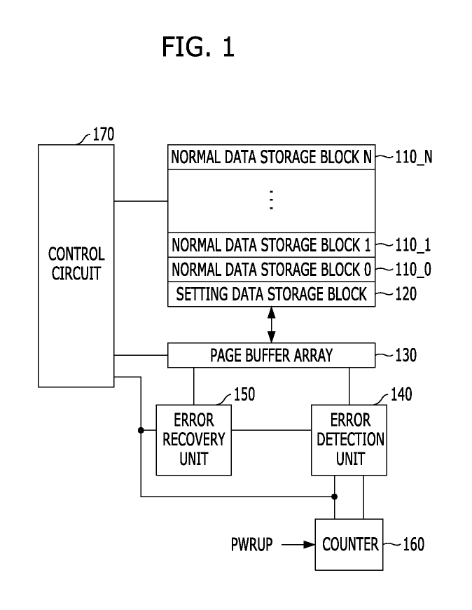

FIG. 1 is a configuration diagram of a nonvolatile memory device in accordance with an embodiment of the present invention.

Referring to FIG. 1, a nonvolatile memory device according to an embodiment of the present invention includes, inter alia: a plurality of normal data storage blocks 110_0 to 110_N, a setting data storage block 120, an access unit 130, an error detection unit 140, an error recovery unit 150, a counter 160, and a control circuit 170.

The plurality of normal data storage blocks 110_0 to 110_N store the normal data or any information for storage from a controller or a user. The number and the block and page sizes of the normal data storage blocks 110_0 to 110_N can be designed in many different ways to suit the memory capacity and the degree of high integration of the nonvolatile memory device.

The setting data storage block 120 stores the setting data or the option data. The setting data, as opposed to the normal data, refer to the information associated with the various settings of the nonvolatile memory device itself, the information associated with repairs of the nonvolatile memory device, etc. The size of the setting data could be much smaller than the size of the normal data, and thus the number of pages and the page size of the setting data storage block 120 may be less than those of the normal data storage blocks 110_0 to 110_N.

The setting data are repeatedly stored a number of times in each page of the setting data storage block 120. For example, the setting data in an 1 byte unit (that is, 8 bits) may be stored for 8 times in each page of the setting data storage block 120. When reading the setting data in the setting data storage block 120, the same 8-byte data that have been repeated read over a majority of times are determined as the true or correct data. Further, the setting data are repeatedly stored in a predetermined number of pages, which for example, may be 3 pages. That is, for example, a byte unit setting data may be written 8 times in each of the 3 pages of the setting data storage block 120, and thus a plurality of pages (for example, 3 pages) in the setting data storage block 120 are written with same data. Although a plurality of pages (for example, 3 pages) are written with the same setting data, a specified page is predesignated for access for using the setting data, and as to which page would be predesignated for access can be determined by the control circuit 170. For example, same setting data may be stored in pages A, B, C of the setting data storage block 120, and one of the pages (for example, the page A) may be predesignated for reading the setting data.

Tables 1-3 show the examples of setting data that could be stored in the pages A, B, C, respectively, of the setting data storage block 120.

Table 1 shows an example of the setting data that may be stored in page A of the setting data storage block 120.

TABLE 1

| | 1st | 2nd | 3rd | 4th | . . . | 8th |
|---|---|---|---|---|---|---|
| CAM_DATA_0 | 11001010 | 11001010 | 11001010 | 11001010 | . . . | 11001010 |
| CAM_DATA_1 | 01001100 | 01001100 | 01001100 | 01001100 | . . . | 01001100 |
| . . . | . . . | . . . | . . . | . . . | . . . | . . . |
| CAM_DATA_N | 10101111 | 10101111 | 10101111 | 10101111 | . . . | 10101111 |

Table 2 shows an example of the setting data that may be stored in page B of the setting data storage block 120.

TABLE 2

| | 1st | 2nd | 3rd | 4th | . . . | 8th |
|---|---|---|---|---|---|---|
| CAM_DATA_0 | 11001010 | 11001010 | 11001010 | 11001010 | . . . | 11001010 |
| CAM_DATA_1 | 01001100 | 01001100 | 01001100 | 01001100 | . . . | 01001100 |
| . . . | . . . | . . . | . . . | . . . | . . . | . . . |
| CAM_DATA N | 10101111 | 10101111 | 10101111 | 10101111 | . . . | 10101111 |

Table 3 shows an example of the setting data that may be stored in the page C of the setting data storage block 120

TABLE 3

| | 1st | 2nd | 3rd | 4th | . . . | 8th |
|---|---|---|---|---|---|---|
| CAM_DATA 0 | 11001010 | 11001010 | 11001010 | 11001010 | . . . | 11001010 |
| CAM_DATA 1 | 01001100 | 01001100 | 01001100 | 01001100 | . . . | 01001100 |
| . . . | . . . | . . . | . . . | . . . | . . . | . . . |
| CAM_DATA N | 10101111 | 10101111 | 10101111 | 10101111 | . . . | 10101111 |

Referring to Tables 1-3, the setting data CAM_DATA 0 to CAM_DATA N were repeatedly stored 8 times in each of the pages A, B, C.

The access unit 130 also known as a page buffer array in a nonvolatile memory device is configured to access the data stored in the plurality of normal data storage blocks 110_0 to 110_N and the setting data storage block 120. The page buffer array 130 is configured to perform programming and reading operations. For example, a programming operation may be performed for storing data in the storage blocks 110_0 to 110_N and 120, and a reading operation may be performed for reading out the data from the storage blocks 110_0 to 110_N and 120.

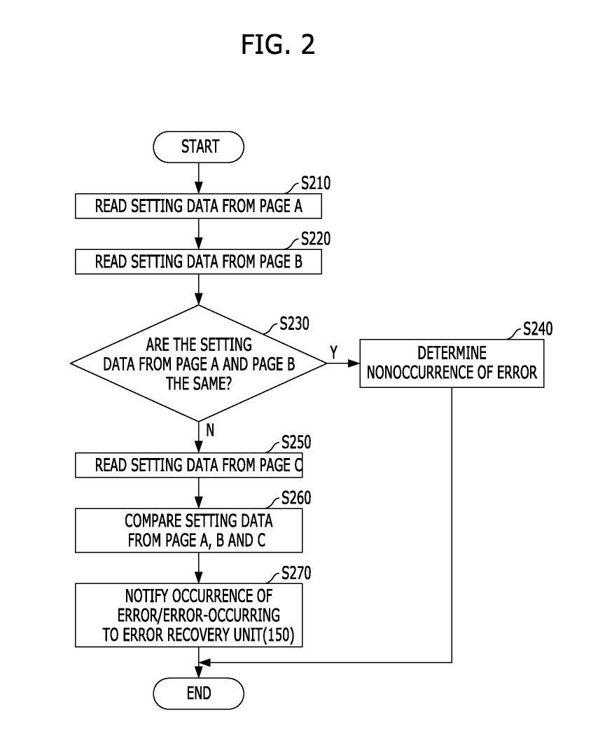

The error detection unit 140 is configured to detect an error in the setting data stored in the setting data storage block 120. The error detection unit 140 is configured to detect any error in the setting data by comparing the setting data that are stored in different regions (i.e., the pages) of the setting data storage block 120. The details of the error detection unit 140 detecting an error in the setting data are described below with reference to FIG. 2. The frequency of operating the error detection unit 140 may be adjusted under the control of the counter 160. For example, the error detection unit 140 may be configured to operate each time the access unit 130 has accessed the setting data for a predetermined number of times.

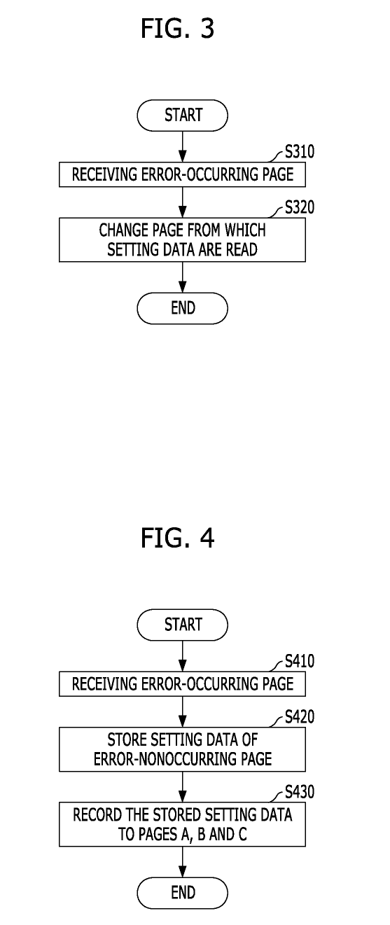

The error recovery unit 150 restores the setting data in the setting data storage block 120 when an error is detected by the error detection unit 140. There are two ways the setting data detected to contain error are restored by the error recovery unit 150. The first recovery scheme, which is described in more detail below with reference to FIG. 3, is directed to changing the setting data storage region or page of the setting data storage block 120 when an error is detected. The second recovery scheme, which is described below in more detail with reference to FIG. 4, is directed to rewriting the setting data storage block 120 when an error is detected.

The counter 160 counts the number of times the setting data stored in the setting data storage block 120 have been accessed by the access unit 130 and, upon determining that the number of times of accessing the setting data has exceeded a predetermined number of times (for example, 50 times), activates the error detection unit 140. This is to prevent excessive current consumption and processing time, which could result if the error detection unit 140 were to operate every time the access unit 130 accesses the setting data to detect an error. The access count value of the counter 160 is initialized each time the error detection unit 140 is activated. The setting data in the setting data storage block 120 are accessed each time the nonvolatile memory device is activated. The power up signal PWRUP is activated each time the nonvolatile memory device is activated. Thus, by counting the number of times the power up signal PWRUP is activated, the counter 160 can figure out the number of times the setting data in the setting data storage block 120 are being accessed by the access unit 130.

The control circuit 170 is configured to perform the overall control of the elements in the nonvolatile memory device. For example, the control circuit 170 selects the data block and the page for access by decoding the commands, addresses, etc. from the controller which controls the nonvolatile memory device and controls the operational sequence of the elements in the nonvolatile memory device.

FIG. 1 shows as an example a setting data storage circuit as applied in a nonvolatile memory device in accordance with an embodiment of the present invention; however, it should be readily understood that the elements of FIG. 1 such as the elements 120, 130, 140, 150, 160 of the setting data storage circuit as well as of other figures of the present application may be used not only in a nonvolatile memory device but also in various kinds of integrated circuit chips in storing suitable setting information.

FIG. 2 is a flow chart of a recovery scheme in which the error detection unit 140 shown in FIG. 1 detects an error according to an embodiment of the present invention.

In step S210, the setting data are read from the page A of the setting data storage block 120 by, for example, the error detection unit 140 through the access unit 130. As shown in Table 1, the setting data CAM_DATA_0 to CAM_DATA_N are repeatedly written several times in the page A, and the same set of data that have been repeatedly written for a majority of times are determined to be read as the true or correct data. For example, if the setting data CAM_DATA_0 is written 7 times as ‘11001010’ and 1 time as ‘11001011’, ‘11001010’ is determined to be the true data because the same bytes were repeatedly written for a majority of times (that is, 7 out of 8 times).

In step S220, the setting data from the page B of the setting data storage block 120 are read by the error detection unit 140 through the access unit 130. The steps of reading the setting data from the pages A and B S210, S220 may operate in a same way to determine the true data from a set of same data that have been read over a majority of times.

In step S230, the setting data read from the page A is compared with the setting data read from the page B. When the setting data read from the pages A and B are identical, it is determined that there is no error in the setting data read from the setting data storage block 120 in step S240.

When the setting data read from the pages A and B are determined as not identical to each other in the step S230, the setting data from the page C of the setting data storage block 120 are read in step S250. Then, the setting data read from the pages A, B, and C are compared, and the setting data that are determined to be same for the majority number of comparisons are determined as the true setting data in step S260. For example, if the setting data read from the page A are different from the setting data read from the pages B and C and if the setting data read from the B and C are identical, the setting data read from the pages B and C would be determined as the true data.

In step S270, the error detection unit 140 provides the error recovery unit 150 with information regarding the occurrence of an error and the identity of the page containing an error, for example, the page A.

In an embodiment of the present invention, it is also possible to read all the setting data from the pages A, B, C in the steps S210, S220, S250 as the setting data are repeatedly written to the pages A, B, C and to compare all the setting data, which were read in the steps S210, S220, S250, in the steps S230 and S260 so as to improve the precision of error detection. That is, all the data are read and compared with one another to determine the true data instead of by comparing the pages A, B, C with each other in the manner as described above. However, in the case of reading and comparing all data, an algorithm that would disregard an error of a small bit number may be implemented.

FIG. 3 is a flow chart for showing a first recovery scheme in which an error is recovered by the error recovery unit 150 shown in FIG. 1 by changing a region (e.g., a page) in the setting data storage block 120 that would be used for reading of the setting data.

Referring to FIG. 3, in step S310, the error recovery unit 150 receives an error-occurring page from the error detection unit 140.

In step S320, the error recovery unit 150 is configured to change the location of the page, if needed, in the setting data storage block 120 that would be used for accessing (which includes reading out) the setting data. For example, if an error has occurred in the page A that was used for accessing the setting data, the error recovery unit 150 may then proceed to designate the page B or C, but not the page A, for accessing the setting data thereafter. If, for example, the page A were the page designated for accessing the setting data and an error occurred in the page B, the page A may continue to be used for accessing the setting data. The first recovery scheme as described above may be implemented in such a manner that the error recovery unit 150 is configured to change the setting of the control circuit 170 regarding the location of the page that would be used for accessing the setting data.

That is, in the step 320, the error recovery unit 150 is configured to change the setting of the control circuit 170, when needed, such that the page identified as having an error would no longer be used for accessing the setting data and another page free of error would be used instead for accessing the setting data.

FIG. 4 is a flow chart showing a second recovery scheme in which the error recovery unit 150 shown in FIG. 1 recovers an error by rewriting the setting data of the setting data storage block 120.

Referring to FIG. 4, in step S410, the error recovery unit 150 is configured to receive the information about the page having an error from the error detection unit 140.

In step S420, the error recovery unit 150 retrieves and stores the setting data from a page without error. For example, if the information received in the step S410 were the page A has an error, the error recovery unit 150 accesses and stores the setting data from the page B or C through the access unit 130.

In step S430, the error recovery unit 150 controls the access unit 130 such that the setting data stored in the step S420 are rewritten (i.e., reprogrammed) in the pages A, B, and C.

In implementing the steps as shown in FIG. 4, the error recovery unit 150 may store the setting data from a page determined to be without error among the pages A, B, and C and rewrite (i.e., reprograms) the stored data in each of the pages A, B, and C. Through this operation, the error-free setting data are stored in all of the pages A, B, and C again.

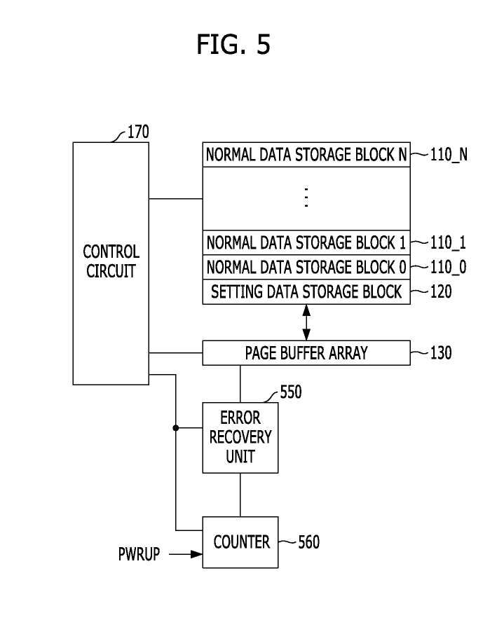

FIG. 5 shows a variation of a setting data storage circuit as applied in a nonvolatile memory device in accordance with an embodiment of the present invention.

Referring to FIG. 5, a nonvolatile memory device includes: a plurality of normal data storage blocks 110_0 to 110_N, a setting data storage block 120, an access unit 130, an error recovery unit 550, a counter 560, and a control circuit 170. The plurality of normal data storage blocks 110_0 to 110_N, the setting data storage block 120, the access unit 130, and the control circuit 170 may be configured in the same manner as in FIG. 1, and the same descriptions described above with respect to these elements in FIG. 1 would apply.

In an embodiment with respect to FIG. 5, the nonvolatile memory device is not configured to detect an error that may be present in the setting data storage block 120, but the error recovery unit 550 is configured to recover the setting data storage block 120 when the number of times the setting data of the setting data storage block 120 were accessed exceeds a predetermined number (for example, equal to or more than 1,000 times). If the number of times the setting data in the setting data storage block 120 were accessed exceeds, for example, 1,000 times, this could support the determination that the reliability of the setting data may be degraded due to the read disturbance.

The counter 560 counts the number of times the data stored in the setting data storage block 120 have been accessed by the access unit 130 and, upon determining that the number of times of accessing the data has exceeded a predetermined number of times (for example, 1000 times), enables the error recovery unit 550 to perform a recovery operation. Each time the recovery unit 550 starts the recovery operation, the count value (i.e., number of access times) stored in the counter 560 is initialized. The setting data stored in the setting data storage block 120 is accessed when the nonvolatile memory device is initialized. The power up signal PWRUP is activated each time the nonvolatile device is powered up. Accordingly, the counter 560 may figure out the number of times the setting data stored in the setting data storage block 120 were accessed by the access unit 130 by counting the number of times of the power-up signal PWRUP were activated.

The error recovery unit 550 recovers the setting data storage block 120 each predetermined number of access times counted by the counter 560. The error recovery unit 550 may recover the setting data storage block 120 according to one of the two following schemes.

The scheme 1 for recovering the setting data storage block 120 by the error recovery unit 550 is as follows.

Each time the number of access times counted by the counter 560 corresponds to a predetermined number of times, the page that is designated and used for accessing the setting data in the setting data storage block 120 is changed. For example, the page A may be accessed to read out the setting data from the setting data storage block 120 when the number of access times corresponds to 1 to 1,000 times, and the page B may be accessed to read out the setting data from the setting data storage block 120 when the number of access times corresponds to 1,001 to 2,000 times, and then the page C may be accessed to read out the setting data from the setting data storage block 120 when the number of access times corresponds to 2,001 to 3,000 times. As the number of access times continues to increase, the pages A, B, and C are alternated for every 1000 accesses so that one among them becomes the page from which the setting data are read out. The above described operations of the error recovery unit 550 may be implemented by the error recovery unit 550 configured to change the setting of the control circuit 170. By changing the page in the setting data storage block 120, from which the setting data are read out, each predetermined number (for example 1000) of access times, the occurrence of an error due to degradation of data may be suppressed.

The scheme 2 for recovering the setting data storage block 120 by the error recovery unit 550 is as follows.

For each predetermined number of access times counted by the counter 560, the setting data are rewritten in the setting data storage block 120. For example, if the number of access times exceeds, for example, 1,000 times, the error recovery unit 550 accesses (for example, reads out and stores) the setting data stored in the page C and then controls the access unit 130 such that the pages A, B, and C are rewritten (or reprogrammed) with the accessed setting data stored in the error recovery unit 550. By rewriting the setting data in the setting data storage block 120 for each predetermined number (e.g., 1000) number of times the setting data were accessed, the reliability of the setting data is secured.

FIG. 5 shows as an example a setting data storage circuit as applied in a nonvolatile memory device in accordance with an embodiment of the present invention; however, it should be readily understood that this is described for illustration purposes only and that the elements of FIG. 5 such as the elements 120, 130, 550, and 560 of the setting data storage circuit as well as of other figures of the present application may be used not only in a nonvolatile memory device but also in various kinds of integrated circuit chips to store setting information.

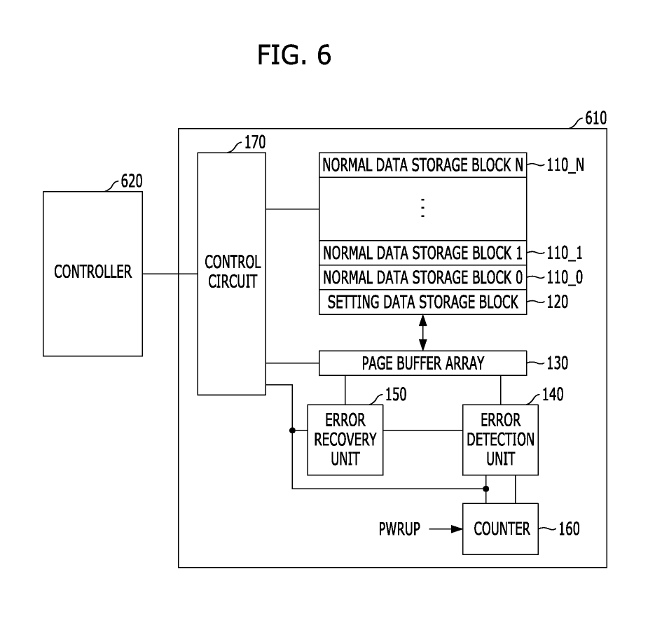

FIG. 6 is a configuration diagram of a memory system in accordance with an embodiment of the present invention.

Referring to FIG. 6, a memory system includes a nonvolatile memory device 610 and a controller 620 for controlling the nonvolatile memory device 610. The recovery scheme by which the nonvolatile memory device 610 recovers an error that may be present in a setting data storage block 120 is similar to that described with respect to FIG. 1, although the controller 620 may also be involved in the recovery operation. Hereafter, the aspects of the recovery scheme associated with FIG. 6 that are different from those associated with FIG. 1 are described below.

When an error is detected, an error detection unit 140 notifies the controller 620 with the information regarding the occurrence of the error and the error-occurring page. Then, the controller 620 transfers an error recovery command along with information necessary for recovering the error to the nonvolatile memory device 610, and an error recovery unit 150 recovers the error in response to the command. If the nonvolatile memory device 610 were to recover an error by itself, there may be difficulties in optimally scheduling the times for recovering an error (for example, it may be more optimal to perform an error recovery operation only in a non-busy time during which the controller 620 does not output a command for performing an error recovery operation). However, when the controller 620 is involved in an error recovery operation according to an embodiment of the present invention, the error recovery operation is performed according to a command from the controller 620, and thus it would be possible to more easily control the timing of performing the error recovery operations.

The communication between the error detection unit 140 and the controller 620 and the communication between the error recovery unit 150 and the controller 620 may be carried out via a control circuit 170.

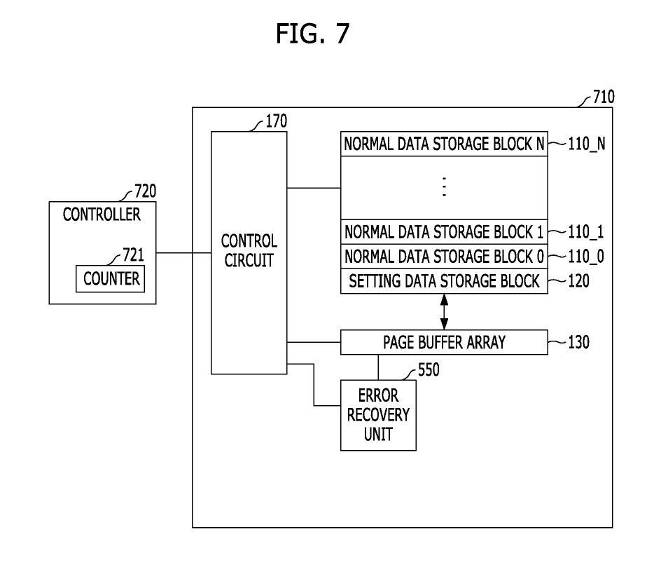

FIG. 7 is a configuration diagram of a memory system in accordance with another embodiment of the present invention.

Referring to FIG. 7, a memory system includes a nonvolatile memory device 710 and a controller 720 for controlling the nonvolatile memory device 710. The recovery scheme by which the nonvolatile memory device 710 recovers an error that may be present in a setting data storage block 120 is similar to that described with respect to FIG. 5, although a counter 721 provided in a controller 720 is utilized to count the number of power-up times of the nonvolatile memory device 710. Hereafter, the aspects of the recovery scheme associated with FIG. 7 that are different from those associated with FIG. 5 will be described.

The counter 721 of the controller 720 counts the number of times the nonvolatile memory device 710 is powered up. Since the controller 720 controls the power-up's of the nonvolatile memory device 710, the controller 720 may easily figure out whether or not the nonvolatile memory device 710 is powered up. If the number of power-up times of the nonvolatile memory device 710 counted by the counter 710 reaches a predetermined number of times (for example, 1,000 times), the controller 720 commands the nonvolatile memory device 710 to recover an error in the setting data storage block 120.

When an error recovery command is activated, the counting number of the counter 710 is initialized.

If the error recovery command is applied from the controller 720 to the nonvolatile memory device 710, an error recovery unit 550 of the nonvolatile memory device 710 would begin operations to recover the setting data storage block 120. The recovery scheme of the error recovery unit 550 would be same as that described with reference to FIG. 5.

Communication between the error recovery unit 550 and the controller 720 may be implemented via a control circuit 170.

As is apparent from the above descriptions, the setting data may be stored in a same region (e.g., a page) or different regions (e.g., pages) in a setting data storage block, and when, an error is detected, a region (e.g., page) for reading the setting data may be changed or the region (e.g., the page) may be written with the setting data. By this operation, the reliability of a setting data storage circuit is improved.

Otherwise, a counting operation is performed to count the number of times the setting data are accessed, for example, read from the setting data storage block, and when the setting data are read at least a predetermined number of times, it can be determined that the reliability of the setting data is degraded, and the region (e.g., the page) for accessing (for example, reading) the setting data may be changed or the setting data may be rewritten. As a result, the reliability of a setting data storage block is improved.

While the present invention has been described with respect to the specific embodiments, it will be apparent to those skilled in the art that various changes and modifications may be made without departing from the spirit and scope of the invention as defined in the following claims.

What is claimed is:

1. A setting data storage circuit comprising:
a setting data storage block configured to store setting data;
an access unit configured to access the setting data in the setting data storage block;
an error detection unit configured to detect an error in the setting data; and
an error recovery unit configured to recover an error in the setting data storage block when the error detection unit detects an error.

2. The setting data storage circuit of claim 1, wherein the same setting data are stored in at least two regions in the setting data storage block.

3. The setting data storage circuit of claim 2, wherein the region comprises a page.

4. The setting data storage circuit of claim 2, wherein the error detection unit detects an error by comparing a plurality of the setting data, each of which is stored in each of at least two regions in the setting data storage block.

5. The setting data storage circuit of claim 2, wherein the error recovery unit is configured to select another region among the at least two regions used for reading the setting data in the setting data storage block when the error detection unit detects an error.

6. The setting data storage circuit of claim 2, wherein the error recovery unit controls the access unit such that the setting data are rewritten in the setting data storage block when the error detection unit detects an error.

7. The setting data storage circuit of claim 1, further comprising:
a counter configured to count the number of times the setting data are accessed by the access unit,
wherein the error detection unit is configured to operate after each predetermined number of times the setting data are accessed by the access unit.

8. The setting data storage circuit of claim 1, further comprising:
a counter configured to count the number of power-up times of a system having the setting data storage circuit,
wherein the error detection unit is configured to operate after each predetermined number of power-up times.

9. A setting data storage circuit comprising:
a setting data storage block configured to store setting data;
an access unit configured to access the setting data in the setting data storage block;
a counter configured to count the number of times the setting data are accessed by the access unit; and
an error recovery unit configured to recover the setting data storage block after each predetermined number of times the setting data are accessed by the access unit.

10. The setting data storage circuit of claim 9, wherein the counter is initialized when the error recovery unit performs a recovery operation.

11. The setting data storage circuit of claim 9, wherein the setting data are stored in at least two regions in the setting data storage block, and
wherein the error recovery unit is configured to select another region among the at least two regions used for reading the setting data in the setting data storage block.

12. The setting data storage circuit of claim 9, wherein the error recovery unit controls the access unit such that the setting data are rewritten in the setting data storage block.

13. The setting data storage circuit of claim 9, wherein the counter is configured to count the number of access times by counting the number of power-up times of a system having the setting data storage circuit.

14. A memory device comprising:
a plurality of normal data storage blocks configured to store normal data;
a setting data storage block configured to store setting data;
a page buffer array configured to access the data of the plurality of normal data storage blocks and the setting data storage block;
an error detection unit configured to detect an error in the setting data; and
an error recovery unit configured to recover an error in the setting data storage block when the error detection unit detects an error.

15. A memory device comprising:
a plurality of normal data storage blocks configured to store normal data;
a setting data storage block configured to store setting data;
a page buffer array configured to access the data of the plurality of normal data storage blocks and the setting data storage block;
a counter configured to count the number of power-up times; and
an error recovery unit configured to recover the setting data storage block after each predetermined number of power up times.

16. A memory system comprising a memory device and a controller for controlling the memory device, the memory device comprising:
a plurality of normal data storage blocks configured to store normal data;
a setting data storage block configured to store setting data;
a page buffer array configured to access the plurality of normal data storage blocks and the setting data storage block; and
an error recovery unit configured to recover the setting data storage block in response to an error recovery command,
wherein the controller counts the number of power-up times of the nonvolatile memory device and outputs the error recovery command to the nonvolatile memory device after each predetermined number of power up times.

17. The memory system of claim 16, wherein the number of power-up times counted by the controller is initialized when the error recovery command is outputted.

18. A memory system comprising a memory device and a controller for controlling the memory device, the memory device comprising:
a plurality of normal data storage blocks configured to store normal data;
a setting data storage block configured to store setting data;
a page buffer array configured to access the plurality of normal data storage blocks and the setting data storage block;
an error detection unit configured to notify occurrence of an error to the controller when an error in the setting data is detected; and
an error recovery unit configured to recover an error in the setting data storage block,
wherein the controller controls the error recovery unit of the nonvolatile memory device to recover an error in the setting data storage block upon being notified of the occurrence of an error.

19. The memory system of claim 18,
wherein the setting data are stored in at least two pages in the setting data storage block, and
wherein the error detection unit detects an error by comparing a plurality of the setting data, each of which is stored in each of at least two pages in the setting data storage blocks.

20. The memory system of claim 19, wherein the error recovery unit is configured to select another page among the at least two pages used for reading the setting data in the setting data storage block under the control of the controller.

21. The memory system of claim 19, wherein the error recovery unit controls the page buffer array under the control of the controller such that the setting data are rewritten in the setting data storage block.
